(19) United States
(12) Patent Application Publication
(10) Pub. No.: US 2002/0174941 A1
(43) Pub. Date: Nov. 28, 2002

(54) Process for the production of a polyethylene film for packages, reinforced and not pierced, provided with localized weakening zones and means for performing such process

(75) Inventor: Antonio Garegnani, Vermezzo (IT)

Correspondence Address: YOUNG & THOMPSON, 745 SOUTH 23RD STREET 2ND FLOOR, ARLINGTON, VA, 22202

(73) Assignee: AKRO-FLEX S.A.S. DI GAREGNANI ANTONIO & C., Vermezzo (IT)

(21) Appl. No.: 10/152,619

(22) Filed: May 23, 2002

(30) Foreign Application Priority Data
May 23, 2001 (IT) RM2001A000281

(51) Int. Cl. B32B 31/08

(52) U.S. Cl. 156/164; 156/226; 156/229

(57) ABSTRACT

The process according to the present invention provides to perform, initially, on the surface of a stretchable film (F) to be reinforced, a plurality of microdamaging (ML) and to join thereafter the microdamaged film (F) with longitudinal reinforcing strips (S), pre-stretched and edged; said edgings are formed by folding inwardly the strip edges, causing thus a further stretching of the strips and a consequent increase of their mechanical resistance.

Said strips (S), which are parallel to one another, cover definite zones of the surface of the film (F) and leave discovered the other zones, so that when the film is stretched beyond a certain elongation, only in zones non covered by the strips (S) tearings and slits are formed, which allows the transpiration of wrapped products. The above said slits form at the localized weakening zones and microdamagings (ML) provided in the film (F) itself.

The present invention relates to an improved process for the production of reinforced stretchable film, preferably of polyethylene, adapted also for palletization of product which must transpire, such as, for example, fruit and vegetable products.

At present the use of stretchable polyethylene films is known for wrapping the goods. Depending on the kind of goods, on their weight and volume, films with different thickness are used and since such films are purchased by weight, it is obvious that the package costs increase proportionally to the thickness of the film and therefore it is useful to limit the thickness of the wrapping films for reducing the production costs.

There are also known wrapping films which are pierced and provided with longitudinal strips, which should be placed between the rows of holes for avoiding their closure and are preferably pre-stretched for increasing their resistance.

A drawback of said films consists in that, if the perforation is performed with material removal, the weight of the film is reduced and the unitary cost (calculated by weight) increases, while if the perforation is made by tearing away, without the removal of material, the weight remains unchanged, but the spools, on which the finished product is wound, have greater radial extension and thus the film length which may be wound is shorter with respect to the previous case.

A further problem of the presently used films consists in that at present it is necessary to use films with a certain thickness (about 35÷40 μm) for palletization of very heavy goods, with evident production costs.

Thus, a first object of the invention is that to realize a reinforced film, which even if having a limited thickness, assures a resistance suitable also for packages of heavy charges.

A second object of the invention is that to realize a reinforced film utilisable for palletising products which must transpire.

This has been attained according to the invention by a process for the realization of a thin stretchable film, reinforced with longitudinal strips, which film is provided with localized weakened zones (or microdamagings), which are distributed on its surface, said reinforced strips being provided with lapelled edges and preferably are pre-stretched for increasing their mechanical resistance. According to a peculiar feature of the invention, said weakening zones are specifically adapted to cause controlled tearings (and thus slits) of the film, when it is stretched beyond a certain elongation during the wrapping operation.

Also an apparatus for the realization of said film by the above said process is an object of the present invention.

The invention will be better understood from the following detailed disclosure with reference to a preferred embodiment thereof, shown in way of a non limiting example in the enclosed drawings, in which:

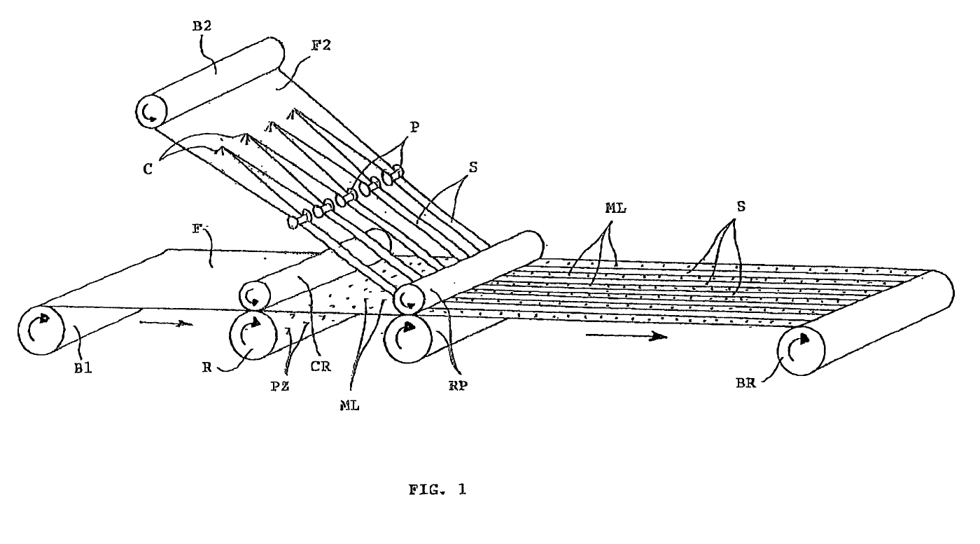

FIG. 1 schematically shows the main elements which form the device for performing the process according to the invention;

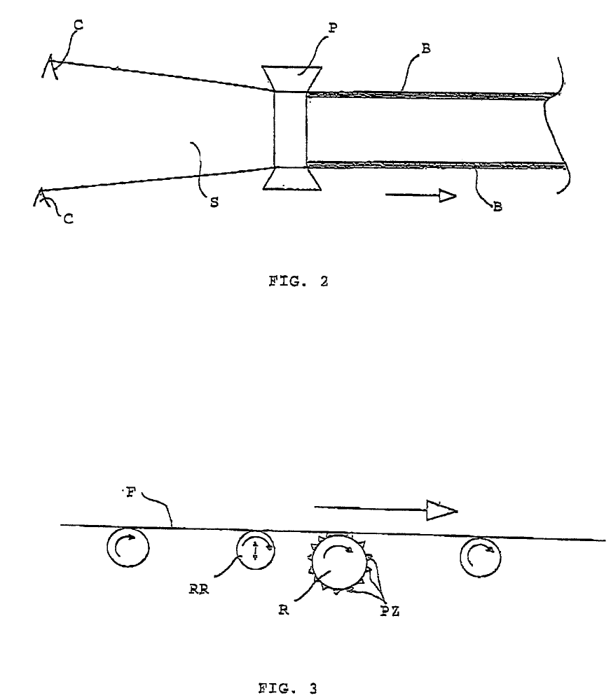

FIG. 2 schematically shows the edging operation of the longitudinal reinforcement strips;

FIG. 3 schematically shows a modification of the device of FIG. 1, relating to means for carrying out microdamages in the film.

The process according to the invention initially provides to carry out, on the surface of the stretchable film F to be reinforced, a plurality of microdamages ML.

After having carried out such operation, the microdamaged film F is joint with longitudinal reinforcing strips S, which preferably are prestretched and edged: said edging is attained by inwardly folding the strip edges, thus causing a further stretching and a consequent resistance increase.

According to a peculiar feature of the present invention, said strips S, parallel to one another, cover determined area of the surface of the film F and leave discovered the other ones: when the film is stretched beyond a certain elongation, only in the area non covered by the strips S damages and slits are formed, which allow the wrapped products to transpire.

Said strips S may be indifferently fed from a spool or directly formed from a second stretchable film F2 (FIG. 1), by guiding said film on a plurality of knives C which divide it in longitudinal strips to be thereafter transversally narrowed by a longitudinal stretching: in this way, starting from a second film F2, preferably having the same width of the microdamaged film F, there are realized parallel strips, which are enough narrow to be joined to the microdamaged film itself, by leaving some uncovered zones.

As already mentioned, said strips S are edged before being joined to the film F: said edging is performed, for example, by moving the strips on pulley P having grooves with a flat bottom and inclined walls (FIG. 3), the width of which at the bottom is less that that of the strips at the inlet, so as to cause the desired folding of the strip edge.

As to the microdamages ML of the film F, in the embodiment shown it is provided to move the film by means of a roller R having small projecting punches PZ and a counter-roller CR pressing the film F on said punches, thus forming local weakenings or damages ML without removing or tearing away the material.

Therefore, the process for producing a microdamaged and reinforced film according to the invention substantially comprises the following steps:

1. Realizing of microdamages ML distributed on the surface of an elastic stretchable film F;

2. Cutting a second film F2 to form longitudinal reinforcement strips S, then stretching and edging these strips for narrowing them and increasing their resistance;

3. Joining said edges strips S and said microdamaged film F to one another by passing them between two pressure rules RP;

4. Winding the microdamaged and reinforced film, thus obtained, on a collecting spool BR.

Obviously, when the strips are already winded on a spool, the above said step 2 does not include the cutting operation.

Referring now particularly to the FIG. 1, the device for carrying out said process comprises:

a first spool B1 on which the first film F, to be microdamaged, is stored;

a roller R provided with projecting punches P2 apt to form small localized weakened zones or microdamages on the film F and a counter-roller CR which presses the film F against said punches PZ;

a second spool BR on which a second film F2, is stocked, which is to be divided in longitudinal strips S to be joined with the previous microdamaged film F, after their stretching and edging B;

a plurality of knives C apt to divide the second film F2 into longitudinal strips S;

a couple of joining pressure rules, rotating in opposite directions, apt to superpose the stretchable edged strips S on the microdamaged film F;

a collecting spool BC for the film provided with localized weakening zones and reinforced by said longitudinal strips S.

It will be now disclosed a preferred embodiment of the invention, in which the film F2, to be cut in longitudinal strips S, moves at a speed lower than that of the microdamaged film F, so that the strips S themselves are longitudinal stretched and narrowed, so as to reach a width slightly greater than that of the pulleys P, which perform the edging thereof.

As clearly shown in the FIG. 1, said punching roller R and said counter-roller CR are placed between the spool B1, on which the film to be microdamaged F is stocked, and the joining pressure rollers RP, a series of knives C being arranged between the spool B2, on which the second film F2, to be cut in longitudinal strips S, and the joining rollers RS, whereas the pulleys P, for edging the strips S, are placed straight above them.

It is obvious, that the width of the strips S depend on the stretching degree thereof and thus it can be changed advantageously by simply varying the tangential speed of the roller B2, on which initially the second film is wound, with respect to that of the joining rollers RP. According to a further peculiar feature of the invention, by changing the stretching degree of the strips, also the edging degree thereof changes.

In other words, the joining rollers RP have the same tangential speed of the spool B1, film F and roller R, with its counter-roller CR, which cause a microdamaging ML of the film F, whereas the spool B2 of the second film F2, to be cut into strips, has a lower speed.

Preferably, said joining rollers consist of a rubberized pressure roller and a motorized metal control motor.

It is also obvious that it would be advisable, even if not obligatory, to provide one or more tension and/or transmission rollers, apt to regularize the motion of the films and/or strips, as well as to maintain them in tensioned and extended condition during their advancement motion between the rollers.

Moreover, it should be also noted that under the equal weight, the locally damaged and reinforced film according to the invention, is substantially more elastic with respect to the films as at present available on the market and thus it is in condition of allowing very much greater elongations during the wrapping operations.

Referring now to FIG. 3, an alternative embodiment of the device is not provided with a counter-roller CR, but is provided, upstream the punching roller P, with as adjustment roller RR variable in its height, so as to exactly regulate the extent of the microdamages ML which are formed in the film F.

Such embodiment is attained by displacement of the adjustment roller RR for changing the distance between the extended film F and the roller R, provided with punches or projections PZ.

Particularly, it is possible to reduce the microdamages ML till to their total elimination (the film F does not contact the punches or projections PZ) or to increase them till to attaining the formation of lacerations in the film F.

Finally, the rotation speed of the punching roller R is adjustable, in preference independently from the advancement speed of the film F.

The present invention has been disclosed and illustrated in a preferred embodiment thereof, but it is obvious that a skilled in the art could perform equivalent modifications and replacements without going out from protection scope of the present invention.

1. A process for the production of a thin, reinforced stretchable wrapping film, characterized in that initially it provides to realize, on the surface of a stretchable film (F) to be reinforced, a plurality of microdamages (ML) and then to join the microdamaged film (F) to longitudinal pre-stretched and edged reinforcement strips; said edging (B) being attained by inwardly folding the strip edges, thus obtaining a further stretching of the strips and a consequently increase of their mechanical resistance.

2. A process for the production of a thin, reinforced stretchable wrapping film according to claim 1, characterized in that said strips (S), parallel to one another, cover established zone of the film (F) surface and leave uncovered other ones, so that the film is stretched beyond a certain elongation degree, in zones not covered by the strips (S) there being formed at some damages or slits, which allow the wrapped products to transpire, said slits being formed localized weakening zones or microdamages (ML) formed in the film (F).

3. A process for the production of a thin, reinforced stretchable wrapping film according to any one of the preceding claims, characterized in that the above said strips are supplied from a spool or are directly obtained from a second stretchable film (F2) by passing said second film on a plurality of knives (C) which divide it into longitudinal strips, which afterwards are transversally narrowed by a longitudinal stretchment, obtaining thus parallel strips (S) which are enough narrow for being joined to the above said microdamaged film (F) and leaving uncovered zones therebetween.

4. A process for the production of a thin, reinforced stretchable wrapping film according to any one of the preceding claims, characterized in that before being joined to the film (F) said strips (S) are edged by passing them through pulleys (P) provided with grooves having a flat bottom and inclined walls, the width at the groove bottom being lesser than that of the incoming strips, so as to cause the desired folding of the strip edges.

5. A process for the production of a thin, reinforced stretchable wrapping film according to any one of the preceding claims, characterized in that for carrying out the microdamages (ML) on the film (F), said film is passed between a roller (R) provided with small projecting punches (PZ) and a counter-roller (CR) which presses the film (F) against said punches, thus causing local weakenings or microdamages (ML), without removing and tearing away of material.

6. A process for production of a stretchable film according to claim 1, characterized in that it substantially comprises the following steps:
a) realizing microdamages (ML) distributed on the surface of the film (F) of an elastic stretchable material;
b) cutting the second film (F2) in longitudinal reinforcing strips (S) and stretching and edging said strips for narrowing them and increasing their resistance;
c) joining said edged strips (S) with said microdamaged film (F) by passing them through a pair of pressure rollers (RP);
d) winding so obtained microdamaged and reinforced film on a collecting spool (BR).

7. A process for production of a stretchable film according to any one of the preceding claims, characterized in that if the strips are already wound on a spool, it is obvious that the above said step (2) does not provide the cutting operation.

8. A device for producing a stretchable film according to the process of claim 1, characterized in that it comprises:
a first spool (B1) on which a first film (F) to be microdamaged is wound;
a roller (R) provided with projecting punches (P1) apt to realize small localized weakenings or microdamages on the film (F) and a counter-roller (CR) which presses the film (F) against said punches (PZ);
a second spool (BR) on which a second film (F2) is collected, which is intended to be divided in longitudinal strips (S) to be joined to the above said microdamaged film (F) after their stretching and edging (B);
a plurality of knives (c) apt to divide the second film (F2) into longitudinal strips (S);
a pair of joining pressure rollers (RP) rotating in opposite directions, apt to superimpose the stretched and edged strips (S) on the microdamaged film (F);
a collection spool (BC) for the film provided with localized weakening zones and reinforced by said longitudinal strips (S);

9. A device according to the preceding claim, characterized in that the film (F2) to be cut in longitudinal strips (S) moves at a speed which is lower than that of the microdamaged film (F), so that the strips are longitudinally stretched and thus narrowed so as to reach a width slightly greater of that of the pulleys (P), which carries out their edging.

10. A device according to claim 8 or 9, characterized in that said punching roller (R) and said counter-roller (CR) are arranged between the spool (B1), on which the film (F) to be microdamaged is stocked, and the joining pressure rollers (RP), the series of knives (C) is arranged between the spool (B2), on which the second film (F2), to be cut in longitudinal strips (S), and the said joining rollers (RP), whereas the pulleys (P), for edging (B) the strips (S), are placed immediately there above.

11. A device according to any one of the claims 8 to 10, characterized in that the above said joining rollers (RP) are formed by a rubberized idle pressure roller and a metallic, motorized control roller.

12. A device according to any one of the claims 8 to 11, characterized in that it comprises one or more tension and/or transmission rollers, apt to regularize the motion of the films and maintain them in tensioned and stretched conditions.

13. A device according to any one of the claims 8 to 12, characterized in that when on the second spool (B2) there are already stocked strips (S), the knives (C) are not utilized.

14. A device according to any one of the claims 8 to 13, characterized in that it has no counter-roller (CR) and is provided with an adjustable roller (RR), which is displaceable for changing the distance between the film (F) and punching roller (R) for adjusting thus the entity of the microdamages (ML).

15. A device according to any one of the preceding claims 8 to 14, characterized in that the roller (R) provided with punches or teeth (PZ) is adjustable as to its speed independently from the advancement speed of the microdamaged film (F).
